(19) United States
(12) Patent Application Publication
(10) Pub. No.: US 2026/0262881 A1
(43) Pub. Date: Sep. 10, 2026

(54) GRIDDLE AND COOKING APPLIANCE

(71) Applicant: WH PRODUCTS, LLC, COLUMBUS, OH (US)

(72) Inventors: ALEXANDRA DEVI UPADHYAYA, LOUISVILLE, KY (US); MICHAEL R. GIEBEL, JOPLIN, MO (US)

(21) Appl. No.: 19/559,093

(22) Filed: Mar. 6, 2026

Related U.S. Application Data
(60) Provisional application No. 63/768,909, filed on Mar. 8, 2025.

(51) Int. Cl. A47J 37/06

(52) U.S. Cl. CPC A47J 37/067

(57) ABSTRACT

A cooking appliance includes a lower portion supporting a cooking surface, like a griddle or grill, and a lid base movably attached to the lower portion. A lid upper portion is attached to the lid base. The lid upper portion may be removably attachable to the lid base. The lid upper portion is configured to move between a collapsed position and an extended position. The lid upper portion can be made of a flexible material, like silicon. The cooking appliance may include an interchangeable second lid upper portion made from a rigid material, like metal. The lower portion also includes a grease receptacle and a storage area that both extend into the lower portion. A first door and as second door are movable between an open position and a closed position to respectively allow access to the grease receptacle and the storage area.

### RELATED APPLICATIONS

This application claims the benefit of U.S. Provisional Application No. 63/768,909 filed Mar. 8, 2025.

### FIELD OF THE INVENTION

Embodiments of the present invention relate to food cooking appliances.

### BACKGROUND

Outdoor cooking, and particularly the use of outdoor barbecue grills, smokers, and griddles, remains very popular. A number of different appliances are currently available to cook food outdoors. All such appliances include a cooking surface to support food items, and historically the most popular outdoor primary cooking surfaces have been grill surfaces. A grill surface typically includes spaced metal elements, such as rods, that support food items above a heat source and permit juices and grease to fall through the spaces between the spaced elements. A grill surface permits flames from some types of heat sources to come in direct contact with food items imparting a particular “flame cooked” flavor. Flame cooking results in grease dripping directly on to heating elements, such as propane burners, which in turn results in unwanted flare ups that can scorch the food in a matter of seconds. Thus, while the ability to flame cook a food item is sometimes desirable, it comes at a cost in terms of temperature control, grease management, and safety, among others.

Indeed, while professional kitchens may include a grill cooking surface, such kitchens nearly universally include a griddle cooking surface. Thus, there is no doubt that griddle cooking is desirable. Griddle cooking surfaces referred to herein include any cooking surfaces having a relatively flat, continuous, heated, normally metal, surface for supporting food. The primary difference between griddle surfaces and grill surfaces is that the former do not include spaced elements that permit direct contact between food and a heat source, such as a propane burner. As a consequence, griddle surfaces also do not permit grease to drip through the cooking surface to the heat source giving griddle surfaces an advantage in terms of temperature control, grease management, and safety due to the absence of any risk of flare ups.

Given the particular advantages of griddle cooking surfaces coupled with the increasing popularity of outdoor cooking, it is only natural that there is a need for well-designed and well-functioning outdoor griddles. Existing outdoor griddles, however, do have some disadvantages as currently designed. For example, existing outdoor griddles must include grease receptacles to collect grease that evolves from cooking foods. Typically, known grease collection receptacles are difficult to access to empty at the end of an outdoor cooking experience. Further, grease receptacles on existing portable outdoor griddles also are typically placed in a location that does not permit a user to stow and access the grease receptacle easily and compactly.

Existing portable outdoor griddles, as well as grills and other cooking appliances, typically include a lid to keep heat in while cooking. The known lids add bulk and weight to existing portable cooking appliances such as griddles. Furthermore, known lids are made of metal in a fixed form and fixed displacement. Existing portable cooking appliances, such as portable outdoor gas griddles also do not currently include lid sets that include interchangeable metal and non-metal lids. Furthermore, existing cooking appliances do not include such lid sets in which the non-metal lid may be removed and used as a container for items, such as food.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are described herein for a cooking appliance. The cooking appliance may comprise a lower portion supporting a cooking surface, a lid base movably attached to the lower portion, and a lid upper portion attached to the lid base. The lid upper portion may be configured to move between a collapsed position and an extended position.

The lid upper portion may include a side wall configured to collapse or extend so as to assume different shapes.

The side wall may comprise a bottom fold, a mid-fold, and an upper fold, wherein in the collapsed position, the bottom fold, the mid-fold, and the upper fold are adjacent to each other.

The bottom fold, the mid-fold, and the upper fold may respectively be defined by thinned portions in a flexible material of the side wall at a first mid crease, a second mid crease, and an upper crease.

The lid upper portion may be removably attachable to the lid base.

The lid upper portion may be made of a flexible material. For instance, the lid upper portion may be made of silicon.

The lid upper portion may include at least one opening positioned to align with at least one corresponding bore in the lid base. The opening and the bore may be configured to receive a mechanical fastener to secure the lid upper portion to the lid base.

The mechanical fastener may be a hand knob having a threaded screw body portion that is configured to engage threads within the at least one bore in the lid base.

The lid base may be pivotally attached to the lower portion with at least one hinge. The lid base may be movable between an open position and a closed position.

The at least one strap may be movably attached to the lid base. The at least one strap may be configured to engage at least one corresponding strap catch on the lower portion. The lid base may be secured in the closed position when the at least one strap engages the at least one strap catch.

The at least one strap may be made of a flexible, elastic material.

The cooking surface may be a griddle.

In another implementation, a cooking appliance may comprise a lower portion supporting a cooking surface, a lid base movably attached to the lower portion, and a lid upper portion attached to the lid base. The lid upper portion may include at least one opening positioned to align with at least one corresponding bore in the lid base. The opening and the bore are configured to receive a mechanical fastener to secure the upper lid portion to the lid base.

The upper lid portion may be a first upper lid portion. The first upper lid portion may be made of a flexible material and is configured to move between a collapsed position and an extended position.

The first upper lid portion may include a side wall configured to be collapsed and extended so as to assume different shapes.

The side wall may comprise a bottom fold, a mid-fold, an upper fold, wherein in the collapsed position, the bottom fold, the mid fold and the upper fold are adjacent each other.

The bottom fold, the mid-fold, the upper fold may be respectively defined by thinned portions in the flexible material of the side wall at a first mid crease, a second mid crease, and an upper crease.

The upper lid portion may be a second upper lid portion made of a rigid metal.

The lid upper portion may be removably attachable to the lid base.

In yet another implementation, a cooking appliance may comprise a lower portion supporting a cooking surface. The lower portion may include a grease receptacle extending into the lower portion and a storage area extending into the lower portion. A first door may be movably attached to the lower portion with a first hinge. The first door may be movable between a closed position and an open position that allows for access to the grease receptacle. The first door may include a first latch for securing the first door in the closed position. The lower portion may also include a second door movably attached to the lower portion with a second hinge. The second door may be movable between a closed position and an open position that allows for access to the storage area. The second door may include a first latch for securing the second door in the closed position. The cooking appliance also may include a lid base movably attached to the lower portion and a lid upper portion removably attachable to the lid base. The lid upper portion may be configured to move between a collapsed position and an extended position. The cooking surface may include a grease drain disposed over the grease receptacle. The grease receptacle may be removable when the first door is in the open position.

In yet another implementation, a cooking appliance may comprise a lower portion supporting a cooking surface, a lid base movably attached to the lower portion, and a lid upper portion attached to the lid base. The lid upper portion may include at least one opening positioned to align with at least one corresponding bore in the lid base. The opening and the bore may be configured to receive a mechanical fastener to attach the upper lid portion to the lid base. The cooking appliance may include a first upper lid portion made from flexible silicon and a second upper lid portion made from a rigid metal. The first upper lid portion and the second upper lid portion may be interchangeable and removably attachable to the lid base.

It is to be understood that both the foregoing general description and the following detailed description are exemplary and explanatory only and are not restrictive of the invention as claimed.

### BRIEF DESCRIPTION OF THE DRAWINGS

The drawings constitute a part of this specification and include exemplary embodiments illustrating various objects and features thereof.

FIG. 1 is a perspective view of the front of an outdoor gas griddle with a first exemplary lid upper portion in an expanded position.

FIG. 2 is a perspective view of the front of an outdoor gas griddle with the first exemplary lid upper portion in a collapsed position.

FIG. 3 is a perspective view of the back of an outdoor gas griddle with the first exemplary lid upper portion in an expanded position.

FIG. 4 is a perspective view of the back of an outdoor gas griddle with the first exemplary lid upper portion in a collapsed position.

FIG. 5 is a handle side view of an outdoor gas griddle with the first exemplary lid upper portion in an expanded position.

FIG. 6 is a handle side view of an outdoor gas griddle with the first exemplary lid upper portion in a collapsed position.

FIG. 7 is a non-handle side view of an outdoor gas griddle with the first exemplary lid upper portion in an expanded position.

FIG. 8 is a non-handle side view of an outdoor gas griddle with the first exemplary lid upper portion in a collapsed position.

FIG. 9 is a top view of an outdoor gas griddle with the first exemplary lid.

FIG. 10 is a cross-sectional side view of an outdoor gas griddle with the first exemplary lid upper portion in an expanded position.

FIG. 11 is a cross-sectional side view of an outdoor gas griddle with the first exemplary lid upper portion in a collapsed position.

FIG. 12 is an exploded perspective view of the front of an outdoor gas griddle with the first exemplary flexible lid upper portion in an expanded position and separated from the lid base.

FIG. 13 is an exploded perspective view of the front of an outdoor gas griddle with a flat metal lid upper portion positioned above and separated from the lid base.

FIG. 14 is a top perspective view of a second exemplary lid upper portion in an expanded position.

FIG. 15 is a bottom perspective view of the second exemplary lid upper portion in an expanded position.

FIG. 16 is a top view of the second exemplary lid upper portion in an expanded position.

FIG. 17 is a front view of the front of an outdoor gas griddle with the second exemplary lid upper portion in an expanded position.

FIG. 18 is a top perspective view of the second exemplary lid upper portion in a collapsed position.

FIG. 19 is a bottom perspective view of the second exemplary lid upper portion in a collapsed position.

FIG. 20 is a top view of the second exemplary lid upper portion in a collapsed position.

FIG. 21 is a front view of the front of an outdoor gas griddle with the second exemplary lid upper position in a collapsed position.

FIG. 22 is a top perspective view of the front of an outdoor gas griddle with the second exemplary lid upper portion in an expanded position.

FIG. 23 is a bottom perspective view of the front of an outdoor gas griddle with the second exemplary lid upper portion in an expanded position.

FIG. 24 is a front view of outdoor gas griddle with the second exemplary lid upper position in an expanded position.

FIG. 25 is a rear view of an outdoor gas griddle with the second exemplary lid upper position in an expanded position.

FIG. 26 is a top view of an outdoor gas griddle with the second exemplary lid upper position in an expanded position.

FIG. 27 is bottom view of an outdoor gas griddle with the second exemplary lid upper position in an expanded position.

FIG. 28 is a left side view of an outdoor gas griddle with the second exemplary lid upper position in an expanded position.

FIG. 29 is a right side view of an outdoor gas griddle with the second exemplary lid upper position in an expanded position.

FIG. 30 is a top perspective view of the front of an outdoor gas griddle with the second exemplary lid upper portion in a collapsed position.

FIG. 31 is a front view of outdoor gas griddle with the second exemplary lid upper position in a collapsed position.

FIG. 32 is a top view of an outdoor gas griddle with the second exemplary lid upper position in a collapsed position.

FIG. 33 is a left side view of an outdoor gas griddle with the second exemplary lid upper position in a collapsed position.

FIG. 34 is a perspective view of the front of an outdoor gas griddle with the lid in an open position.

FIG. 35 is a perspective non-handle side view of the back of an outdoor gas griddle with the grease receptacle door and the storage area door unlatched and open.

FIG. 36 is a perspective handle side view of the back of an outdoor gas griddle with the grease receptacle door and the storage area door unlatched and open.

### DETAILED DESCRIPTION

As required, detailed aspects of the present application are disclosed herein, however, it is to be understood that the disclosed aspects are merely exemplary, which may be embodied in various forms. Therefore, specific structural and functional details disclosed herein are not to be interpreted as limiting, but merely as a basis for the claims and as a representative basis for teaching one skilled in the art how to variously employ the present application in virtually any appropriately detailed structure.

One or more techniques and systems are described herein for a cooking appliance, specifically a portable outdoor cooking appliance, such as a portable gas griddle, that incorporates a grease collection system and receptacle that is easy to stow for transportation, compact, and easy to access for grease removal. The outdoor griddle may include one or more grease collection receptacles disposed in a location conducive to stowing for transportation of the griddle, yet easily accessed during use for emptying. A cooking appliance, such as a portable griddle, may include a lid that is lighter than known lids, with a variable displacement as compared with known lids, and/or capable of assuming multiple shapes and forms as compared with known lids. As such, some embodiments of the cooking appliance may be a portable outdoor cooking appliance, such as a portable gas griddle, that includes a light, flexible, variable displacement and variable form lid. Some embodiments of the cooking appliance may be a portable gas griddle, that includes a non-metallic lid made of a material such as silicone or like flexible materials. Further, some embodiments of the cooking appliance may be a portable outdoor gas griddle that includes a set of interchangeable lids made of metal and non-metal materials that are easily and quickly interchanged.

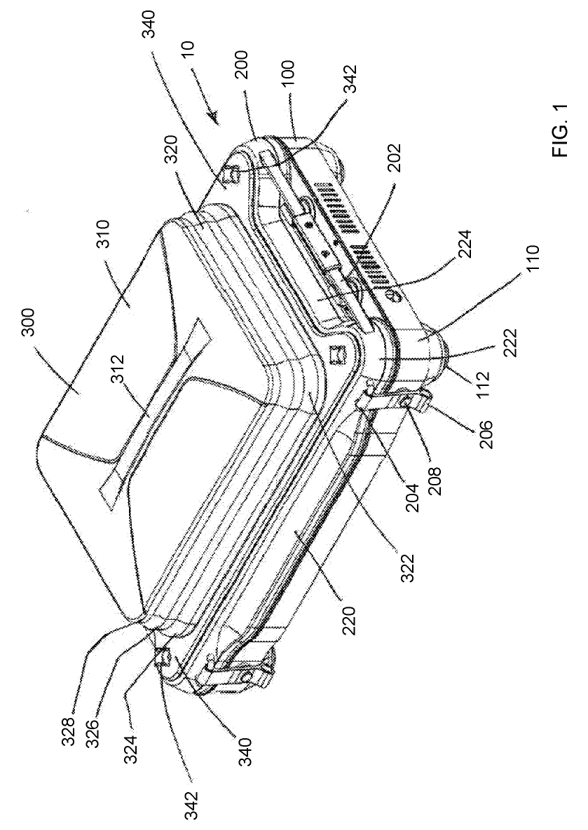

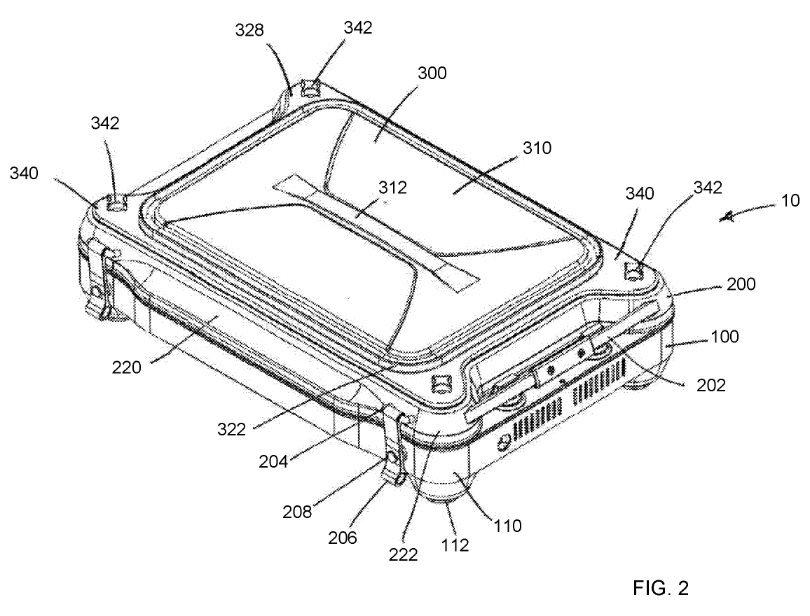

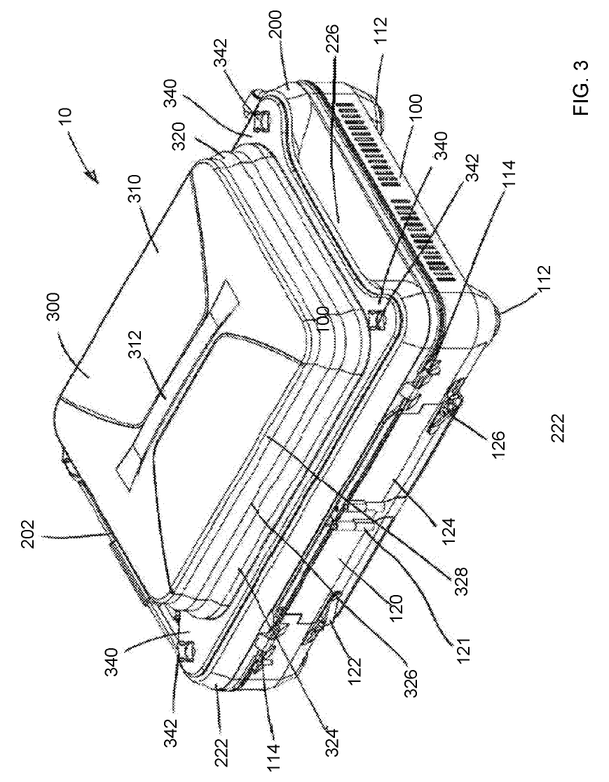

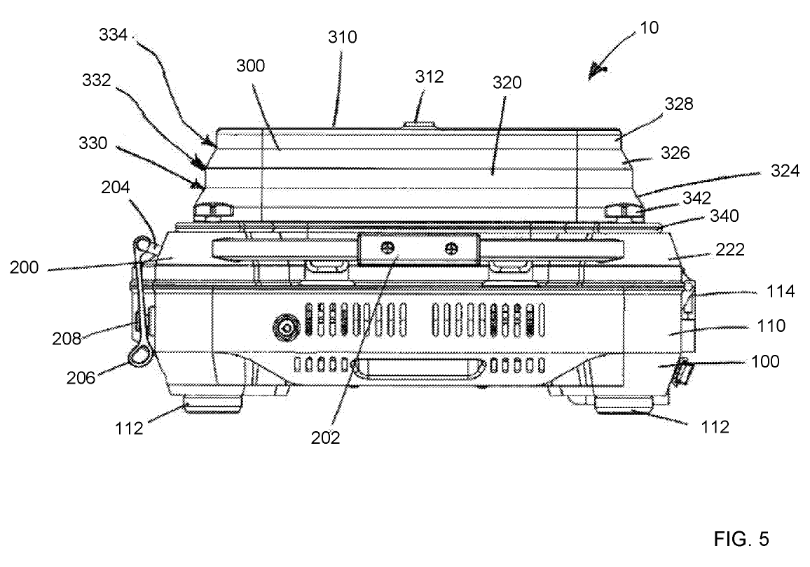

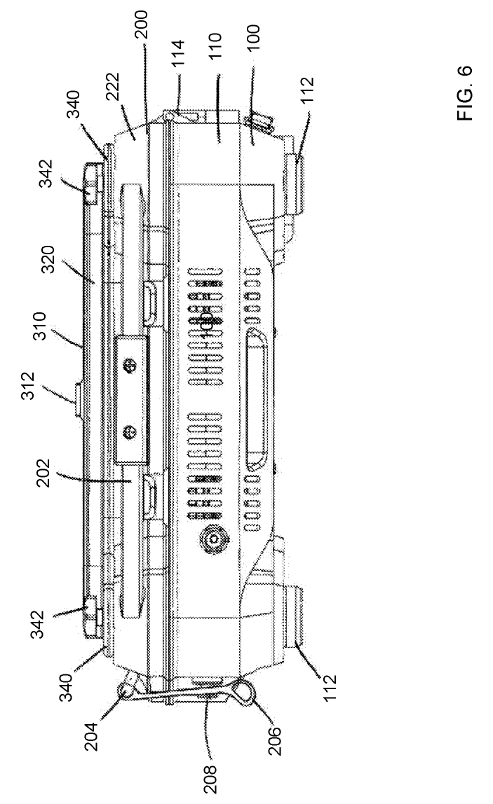

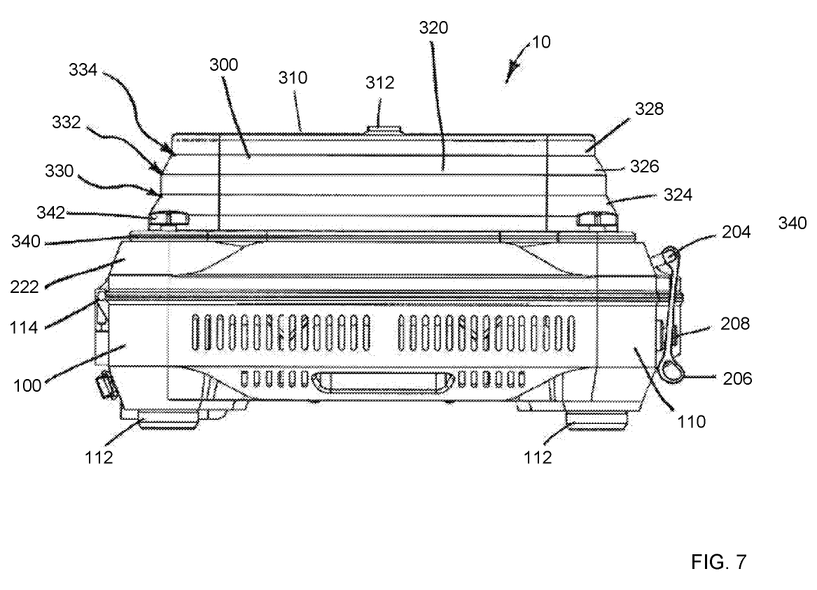

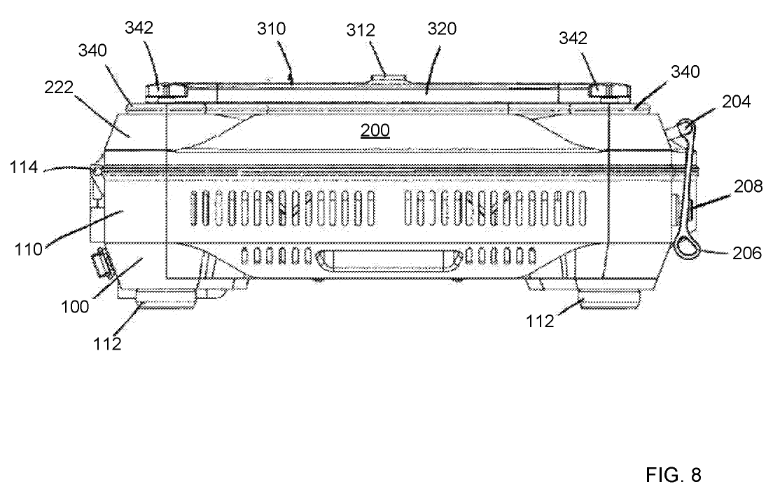

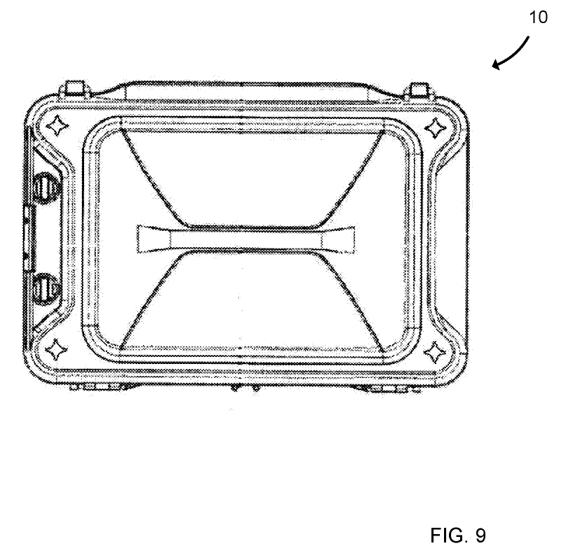

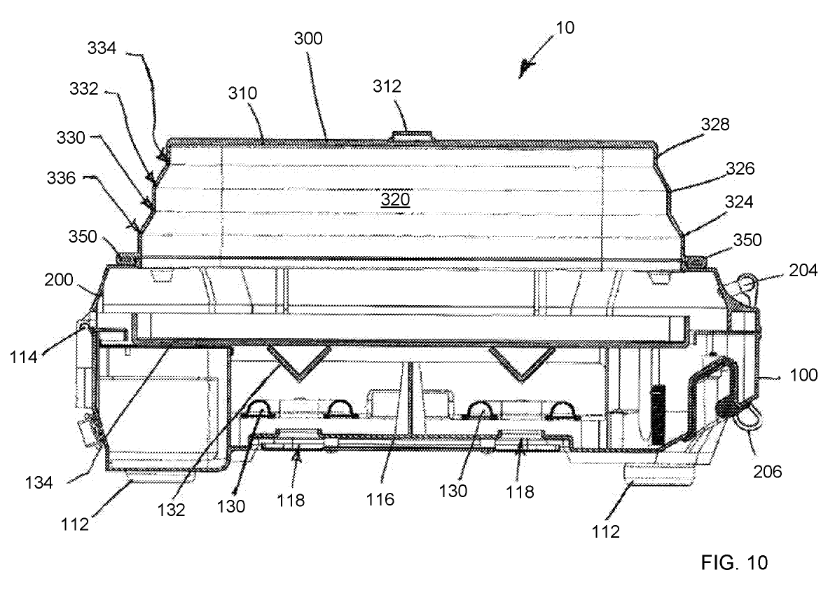

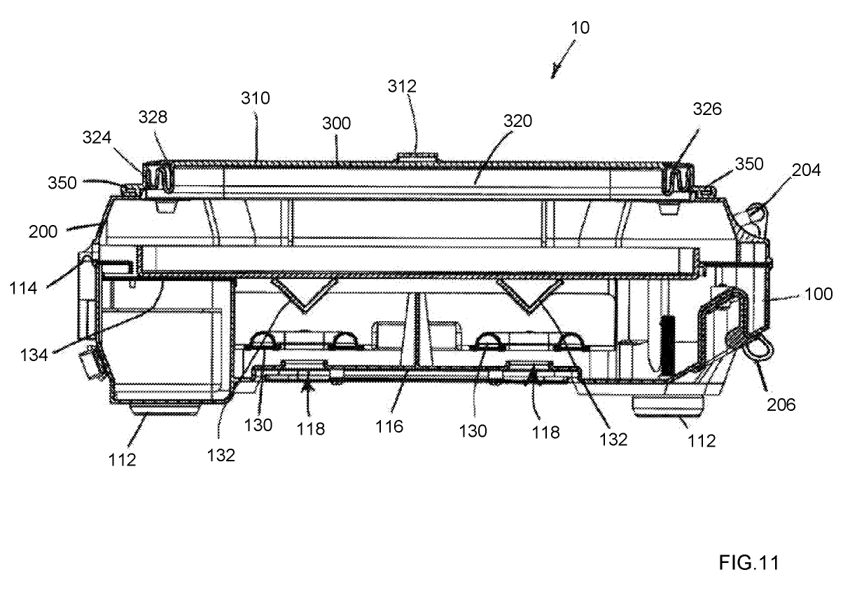

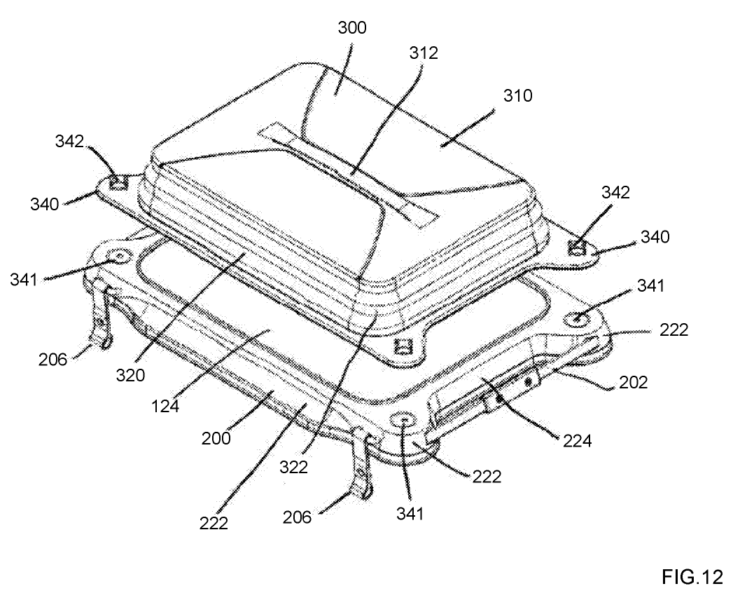

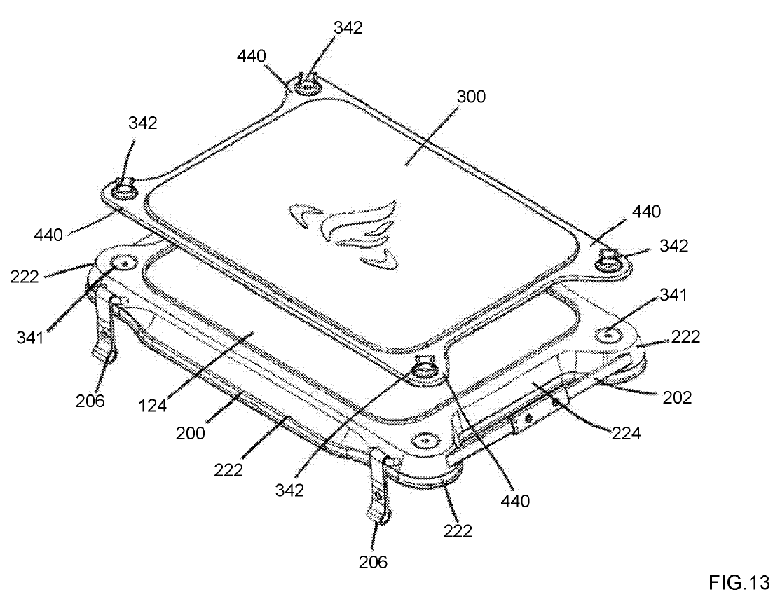

Reference will now be made in detail to embodiments of the present invention, examples of which are illustrated in the accompanying drawings. With reference to FIGS. 1-15, an outdoor cooking appliance / portable outdoor gas griddle 10 may include a lower portion 100 forming the base of the griddle. The lower portion 100 may be substantially rectangular when viewed from above and may include four rounded corners 110. A support foot 112 may be attached to the lower portion 100 below each of the four rounded corners. The rounded corners 110 may make it easier to place the griddle 10 in a soft carry case.

The lower portion 100 may be defined in part by a bottom wall 116 that has one or more air inlets 118 provided therethrough. The air inlets 118 may provide air flow to one or more burners 130 that are contained within the lower portion 100 and which are configured to burn propane, natural gas or like liquid and gaseous fuels. First and second fuel controllers 140 and 142 may be provided on the lower portion 100 to control the flow of fuel to the burners 130. The burners 130 may be disposed below, and used to heat, a griddle plate 134 that is supported by one or more griddle plate supports 132. In alternative embodiments, a grill grate may be substituted for the griddle plate 134. The griddle plate 134 may be removed from the lower portion 100 by lifting it away from the griddle plate supports 132 when the lid 200 is open. The griddle plate 134 may be made from cast iron, carbon steel, stainless steel, or some other suitable heat conductive material. The griddle plate 134 may include a grease drain 144 disposed at a back wall of the griddle plate 134. Alternatively, the grease drain 144 may be disposed at a side wall of the griddle plate 134. The grease drain 144 may be any suitable shape and/or size. For instance, as illustrated, the grease drain 144 may be an elongated slot extending through the griddle plate 134. The grease drain 144 may be disposed above a grease receptacle 146.

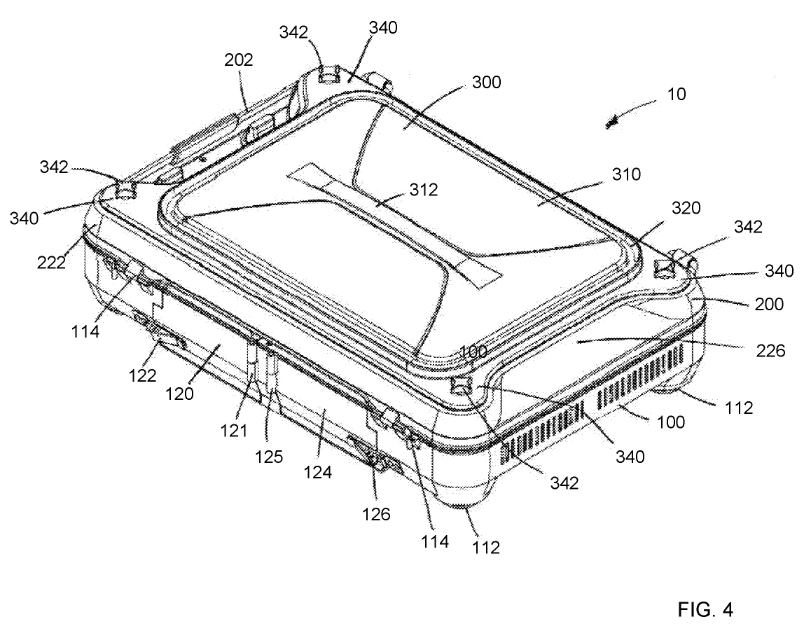

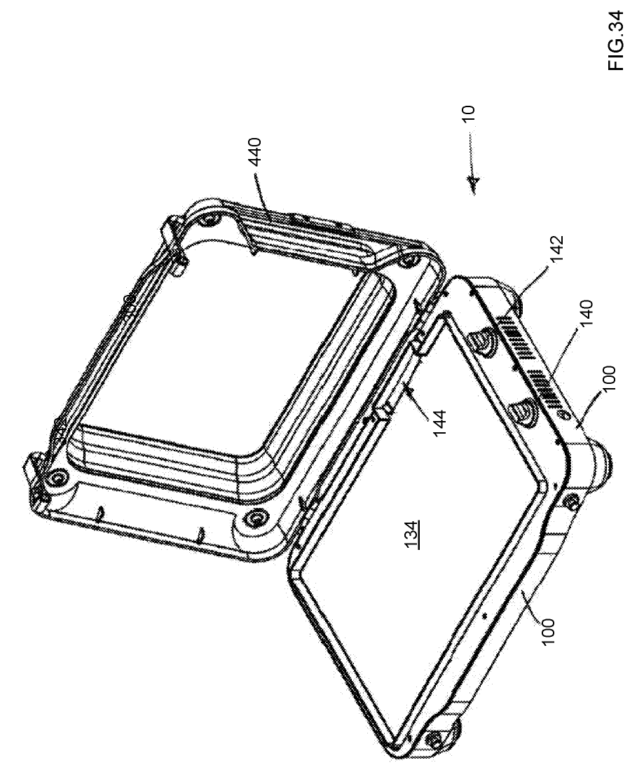

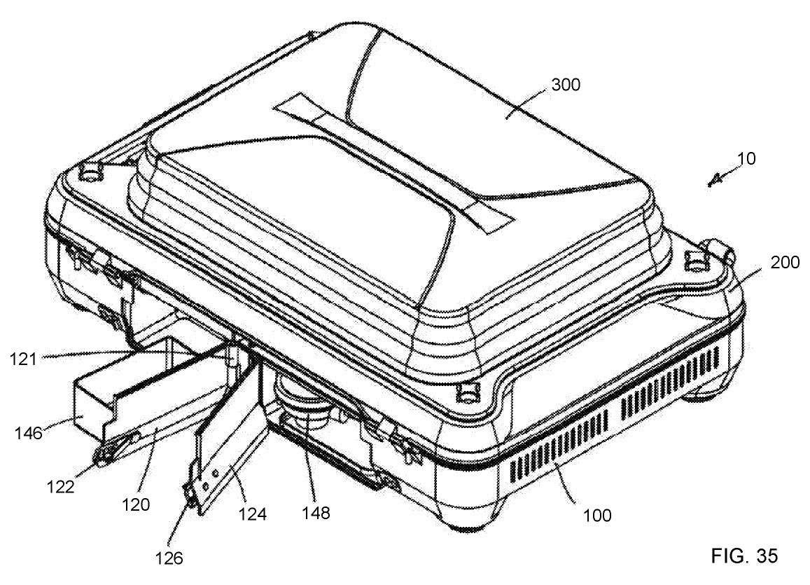

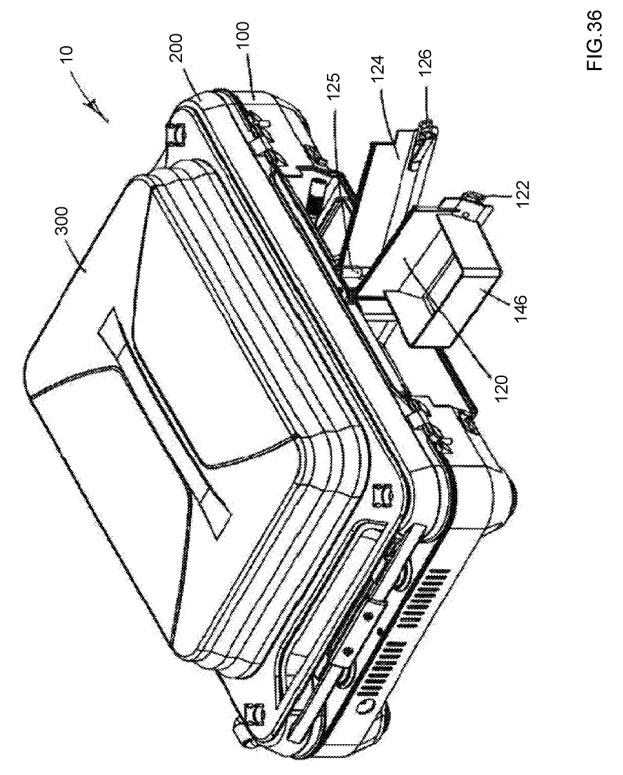

Turning to FIGS. 4, 25, and 34-36, the lower portion 100 may include a grease receptacle door 120 pivotally attached to the lower portion by a grease receptacle door hinge 121. For instance, the grease receptacle door 120 may be located in the back of the lower portion 100. A grease receptacle door latch 122 may be used to lock the grease receptacle door 120 in a closed position to stow the grease receptacle 146 during use, storage, and transport of the griddle 10. When stowed, the grease receptacle 146 is positioned directly below the grease drain 144 in the griddle plate 134. When the grease receptacle door latch 122 is unlocked, the grease receptacle door 120 may swing outward permitting access to the grease receptacle 146 which may be permanently or removably attached to the inside of the grease receptacle door. The grease receptacle 146 may be configured to receive grease liners. The grease liners may be removable from the receptacle and disposable. The back of the lower portion 100 also may include a storage area door 124 pivotally attached to the lower portion by a storage area door hinge 125. A storage area door latch 126 may be used to lock the storage area door 124 in a closed position to stow a regulator and hose assembly 148 or other items during storage and transport of the griddle 10. When the storage area door latch 126 is unlocked, the storage area door 124 may swing outward permitting access to the storage area in the lower portion 100.

Returning to FIGS. 1-13, a lid 200 may be pivotally attached to the lower portion 100 by one or more lid hinges 114. The lid 200 may include a lid base 220 and a flexible lid upper portion 300 attached to the lid base 220. In some embodiments, the lid upper portion 300 may be removably attachable to the lid base 220. The lid base 220 may be substantially rectangular and of like area and footprint to the lower portion 100 when viewed from above. The lid base 220 may include four rounded lid base bosses 222 that rest above, and are of like dimension and shape to, the rounded corners 110 of the lower portion 100. The pair of lid base bosses 222 provided at left and right sides of the lid base 220 may define a lid base handle recess 224 on the right side, and a lid base recess 226 on the left side. A lid handle 202 may extend between the right side lid base bosses 222 so as to span the lid base handle recess 224. The lid handle recess 224 is configured to allow a user to securely grasp the lid handle 202 in order to open and close the lid 200 as well as to carry the entirety of the griddle 10 between cooking locations.

The front left and right sides of the lid base 220 each may have a U-shaped lid strap mount 204 fastened thereto. The forward left and right sides of the lower portion 100 each may have a lid strap catch 208 connected to and extending away from the lower portion directly below the lid strap mounts 204. A flexible lid strap 206 may be permanently connected to each of the lid strap mounts 204. Each lid strap 206 may include an opening adapted to receive and removably connect to a corresponding lid strap catch 208. The lid straps 206 may be constructed of stretchable material that may be pulled down and over the lid strap catches 208 so that when the lid base 220 and the lower portion 100 are in a collapsed position (as shown in FIGS. 1-12), the lid base and lower portion are held securely together in a clamshell fashion. It is appreciated that alternative lid locking assemblies may be substituted for the lid strap and catch assembly described herein. The lid straps may be made of rubber, silicon, an elastomer, or some of suitable elastic, resilient, and flexible materials. The lid locking assemblies permit the griddle 10 to be securely transported and carried by the handle 202 without falling open accidentally.

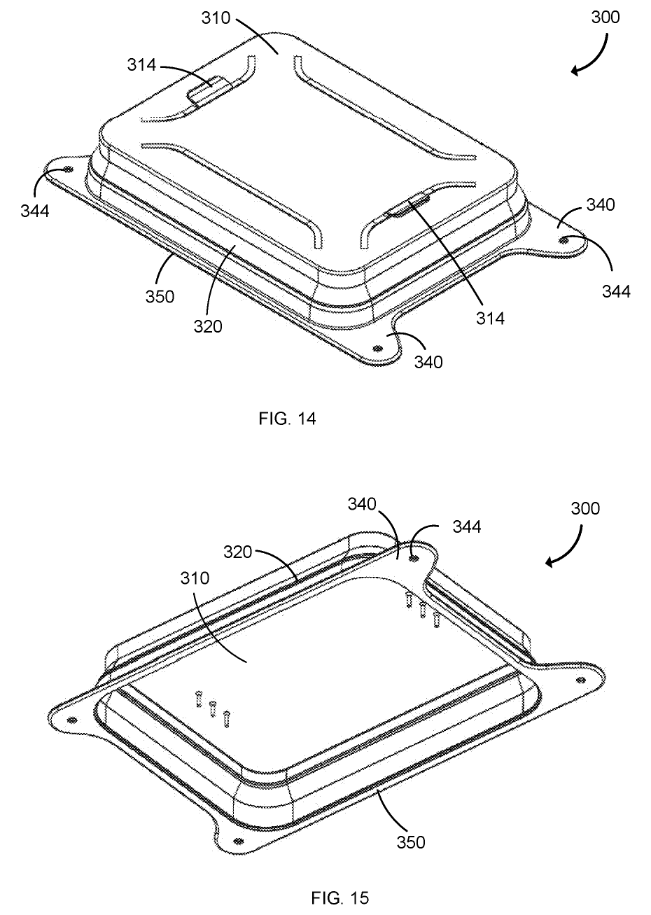

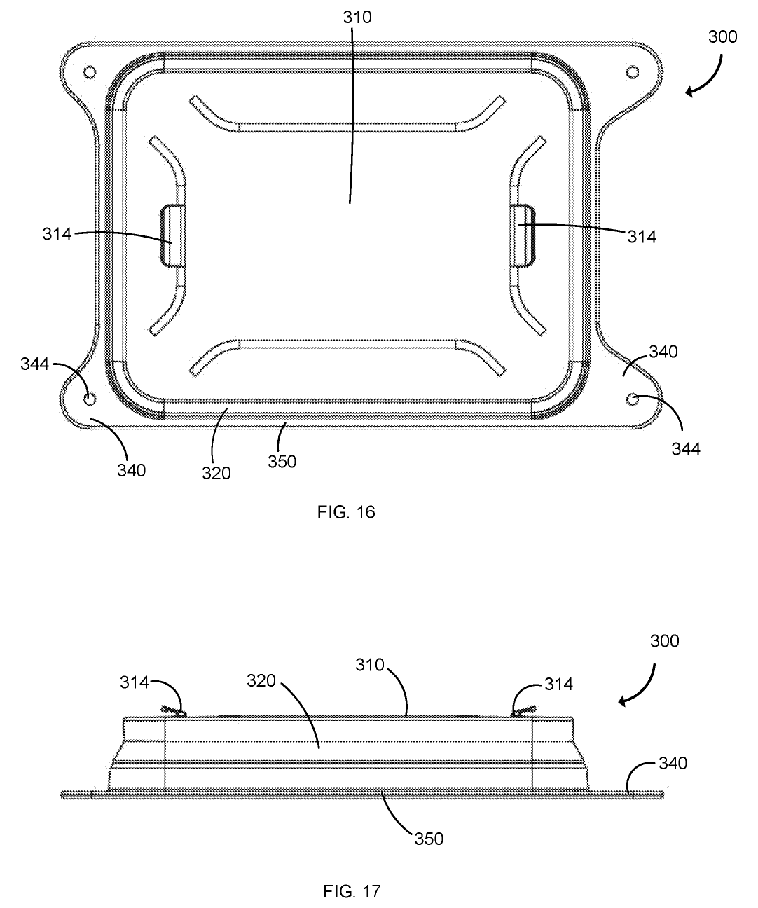

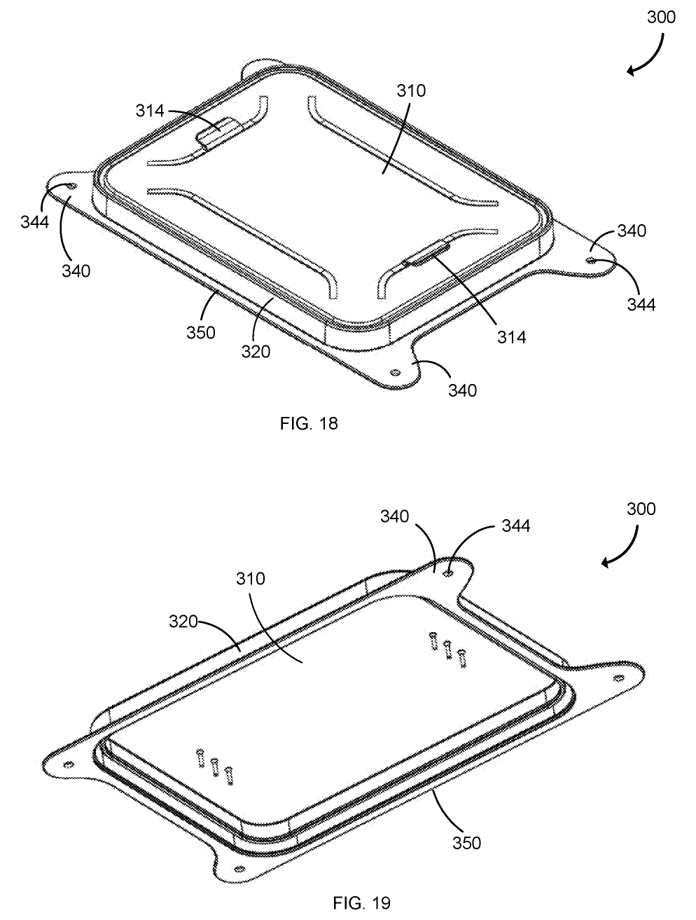

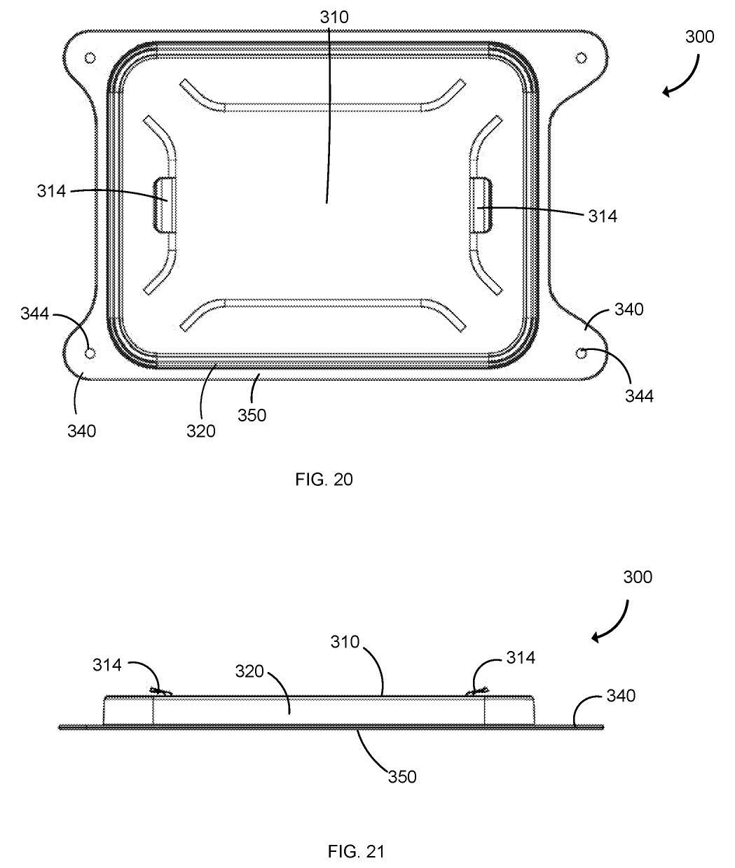

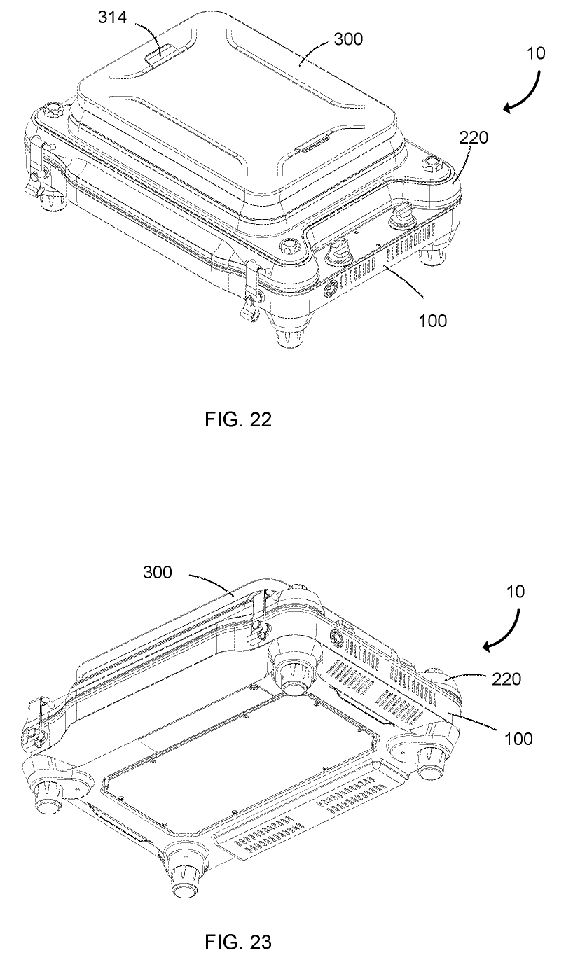

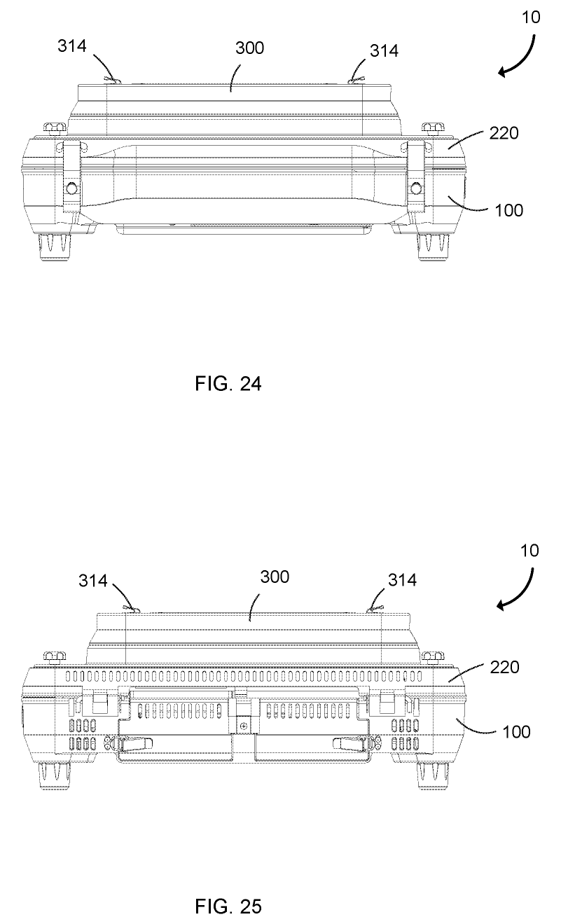

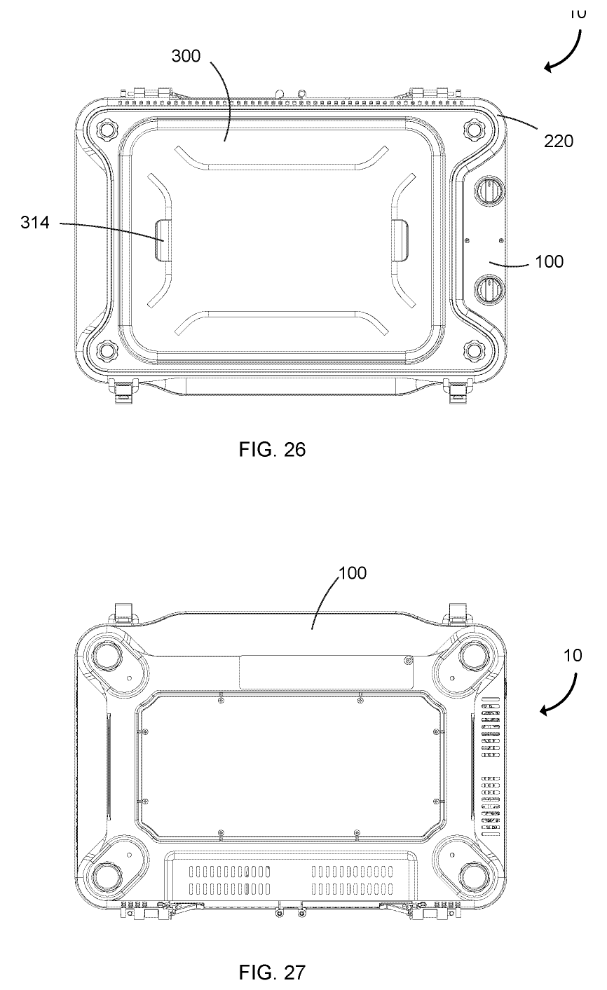

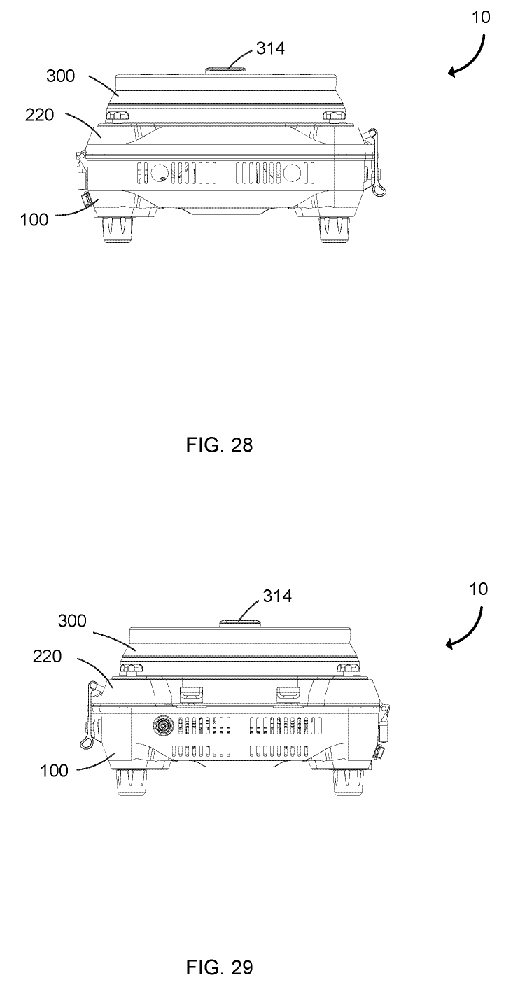

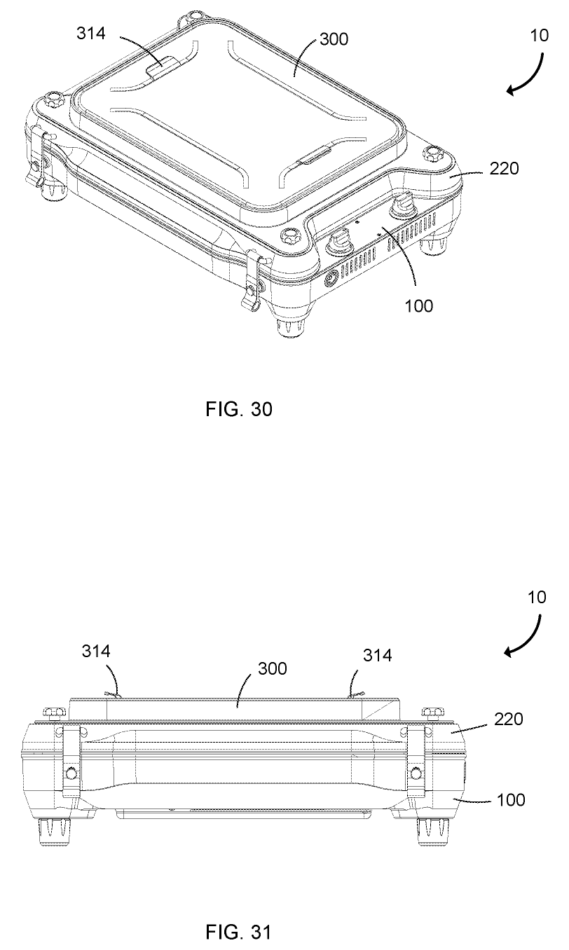

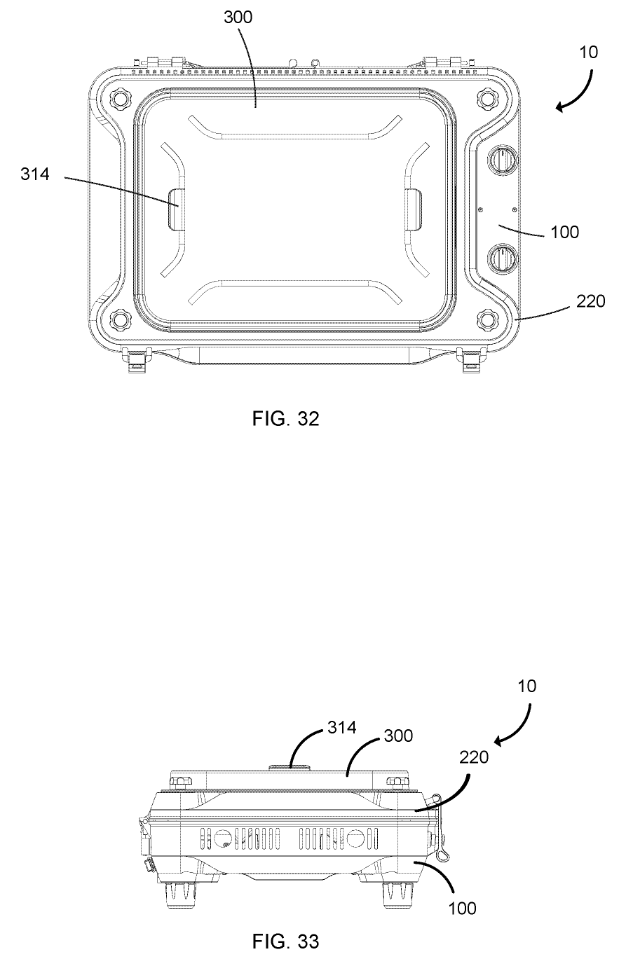

The flexible lid upper portion 300 may include a lid upper surface 310 and a collapsible lid upper portion side wall 320. The flexible lid upper portion 300 may be substantially rectangular when viewed from above while incorporating four upper portion rounded corners 322. A flexible handle 312 may be provided along the outside of the lid upper surface 310 either formed integrally with the lid upper surface 310 or attached thereto. In an alternative embodiment, the lid upper surface 310 may include one or more handles disposed at opposite sides of the flexible upper lid For instance, as illustrated in FIGS. 14-33, the lid upper surface 310 can have a handle 314 at proximal to each side of the lid upper portion 300. A lid upper portion rim 350 may be provided at the opposite end of the side wall 320 from the lid upper surface 310. The lid upper portion rim 350 may define a recess formed by the flexible lid upper portion 300. The lid upper portion rim 350 may be comprised of a thickened portion of flexible material as compared with the thickness of the flexible material used for the lid upper portion side wall 320. The lid upper portion rim 350 may include four lid upper portion bosses or flaps 340 extending away from each of the four lid upper portion rounded corners 322. Each of the lid upper portion bosses 340 may include an opening 344 configured to receive a screw body extending downward from a screw knob 342. Alternatively, the openings 344 may extend through a flange that extends around the respective perimeter or along the sides of the lid upper portion 300.

The flexible lid upper portion 300 may be removably attached to the lid base 220 by positioning each of the four lid upper portion bosses 340 above corresponding lid base bosses 222. Once so positioned, the screw bodies of the screw knobs 342 may be pushed through the openings 344 in the lid upper portion bosses 340 and rotated so that the screw bodies engage screw bores 341 provided in the lid base 220. The screw knobs 342 may be tightened until the flexible lid upper portion 300 is securely fastened to the lid base 220. When removed, the flexible lid upper portion 300 may be interchanged with a rigid metal lid upper portion 400 by positioning each of four metal lid upper portion bosses 440 above corresponding lid base bosses 222. Once so positioned, the screw bodies of the screw knobs 342 may be pushed through the openings 444 in the metal lid upper portion bosses 440 and rotated so that the screw bodies engage screw bores 341 provided in the lid base 220. It will be appreciated the lid upper portion 300 or the metal lid upper portion 400 may be fastened to the lid base 220 with alternative means, like a pin, rivet, screw, bolt, anchor, or some other suitable mechanical fastener. Further, while the above lid upper portion 300 or the metal lid upper portion 400 are described as having bosses, the openings may extend through a flange that extends around the respective perimeters or along the sides of the respective lid upper portion 300 or the metal lid upper portion 400.

Preferably the flexible lid upper portion 300 may be comprised of silicone or like material which permits it to assume collapsed and extended positions. In order to collapse in a desired manner, the flexible lid upper portion side wall 320 may include a side wall bottom fold 324, a side wall mid fold 326, and a side wall upper fold 328. Each of these folds in the flexible material may be defined by thinned portions in the flexible material at a side wall first mid crease 330, a side wall second mid crease 332, a side wall upper crease 334, and a side wall lower crease 336. The side wall 320 may allow the lid upper surface 310 to telescopically extend away from the lid upper portion rim 350. When in the collapsed position, the side wall 320 may be folded such that the side wall bottom fold 324, the side wall mid fold 326, and the side wall upper fold 328 are all adjacent to each other and the overall height of the flexible lid upper portion is minimized. In other words, the distance between the lid upper portion rim 350 and the lid upper surface 310 may be minimized. As such, in the collapsed position, the overall height of the cooking appliance 10 may be minimized, and the cooking appliance 10 can occupy less space, for instance when stored. In the extended position, the side wall 320 is extended such that the distance between the lid upper portion rim 350 and the lid upper surface 310 is increased. As such, in the extended position, the volume of the recess in the interior of the lid upper portion 300 defined by the lid upper surface 310, the side wall 320, and the lid upper portion rim 350 is increased. This increase in space allows for the lid 200 to be closed over the lower portion 100 if there is food on the griddle plate 134.

It is to be understood that while certain embodiments and/or aspects have been shown and described, the application is not limited thereto and encompasses various other embodiments and aspects.

What is claimed is:

1. A cooking appliance, comprising:
a lower portion supporting a cooking surface;
a lid base movably attached to the lower portion; and
a lid upper portion attached to the lid base, the lid upper portion being configured to move between a collapsed position and an extended position.

2. The cooking appliance of claim 1, wherein said lid upper portion includes a side wall configured to collapse and extend so as to assume different shapes.

3. The cooking appliance of claim 2, the side wall comprising a bottom fold, a mid-fold, and an upper fold, wherein in the collapsed position, the bottom fold, the mid-fold, and the upper fold are adjacent each other.

4. The cooking appliance of claim 3, wherein the bottom fold, the mid fold, and the upper fold are respectively defined by thinned portions in a flexible material of the side wall at a first mid crease, a second mid crease, and an upper crease.

5. The cooking appliance of claim 1, wherein the lid upper portion is made of a flexible material.

6. The cooking appliance of claim 1, wherein the lid upper portion is removably attachable to the lid base.

7. The cooking appliance of claim 1, wherein the lid upper portion includes at least one opening positioned to align with at least one corresponding bore in the lid base, wherein the opening and the bore are configured to receive a mechanical fastener to secure the upper lid portion to the lid base.

8. The cooking appliance of claim 7, wherein the mechanical fastener is a hand knob having a threaded screw body portion that is configured to engage threads within the at least one bore in the lid base.

9. The cooking appliance of claim 1, wherein the lid base is pivotally attached to the lower portion with at least one hinge, the lid base being movable between an open position and a closed position.

10. The cooking appliance of claim 9, further comprising at least one strap movably attached to the lid base, the at least one strap being configured to engage at least one corresponding strap catch on the lower portion, wherein the lid base is secured in the closed position when the at least one strap engages the at least one strap catch.

11. The cooking appliance of claim 10, the at least one strap being made of a flexible, elastic material.

12. A cooking appliance, comprising:
a lower portion supporting a cooking surface;
a lid base movably attached to the lower portion; and
a lid upper portion attached to the lid base, the lid upper portion includes at least one opening positioned to align with at least one corresponding bore in the lid base, wherein the opening and the bore are configured to receive a mechanical fastener to attach the upper lid portion to the lid base.

13. The cooking appliance of claim 12, wherein the upper lid portion is a first upper lid portion, wherein the first upper lid portion is made of a flexible material and is configured to move between a collapsed position and an extended position.

14. The cooking appliance of claim 13, wherein said first upper lid portion includes a side wall configured to be collapsed and extended so as to assume different shapes.

15. The cooking appliance of claim 14, the side wall comprising a bottom fold, a mid-fold, an upper fold, wherein in the collapsed position, the bottom fold, the mid fold and the upper fold are adjacent each other.

16. The cooking appliance of claim 15, wherein the bottom fold, the mid fold, the upper fold are respectively defined by thinned portions in the flexible material of the side wall at a first mid crease, a second mid crease, and an upper crease.

17. The cooking appliance of claim 12, wherein the upper lid portion is a second upper lid portion, wherein the second upper lid portion is made of a rigid metal.

18. The cooking appliance of claim 12, wherein the lid upper portion is removably attachable to the lid base.

19. A cooking appliance, comprising:
a lower portion supporting a cooking surface, the lower portion comprising:
a grease receptacle extending into the lower portion;
a storage area extending into the lower portion;
a first door movably attached to the lower portion with a first hinge, the first door movable between a closed position and an open position that allows for access to the grease receptacle, the first door including a first latch for securing the first door in the closed position; and
a second door movably attached to the lower portion with a second hinge, the second door movable between a closed position and an open position that allows for access to the storage area, the second door including a first latch for securing the second door in the closed position;
a lid base movably attached to the lower portion; and
a lid upper portion removably attachable to the lid base, the lid upper portion being configured to move between a collapsed position and an extended position
wherein the cooking surface includes a grease drain disposed over the grease receptacle.

20. The cooking appliance of claim 19, wherein the grease receptacle is removable when the first door is in the open position.
